(19) United States
(12) Patent Application Publication
(10) Pub. No.: US 2026/0015208 A1
(43) Pub. Date: Jan. 15, 2026

(54) DAVIT ARM BASE AND METHOD OF USING THE SAME

(71) Applicant: Petro Mechanical Services, LLC, Longview, TX (US)

(72) Inventors: Thad Pennington, Center Point, LA (US); Mark Fischer, Montgomery, TX (US); Danny R. Watkins, Gilmer, TX (US)

(21) Appl. No.: 18/905,262

(22) Filed: Oct. 3, 2024

Related U.S. Application Data
(60) Provisional application No. 63/670,465, filed on Jul. 12, 2024.

(51) Int. Cl. B66C 23/62

(52) U.S. Cl. CPC B66C 23/62

(57) ABSTRACT

A davit arm base for supporting a davit arm. The davit arm base includes a base plate for securing a davit base mount thereto and a sleeve extending from the base plate for extending down into a mouse hole for an oil and gas well. A method that includes the step of sliding a sleeve of a davit arm base into a mouse hole and supporting a davit arm with via a base plate of the davit arm base.

### STATEMENT REGARDING FEDERALLY SPONSORED RESEARCH OR DEVELOPMENT

Not applicable.

### CROSS-REFERENCE TO RELATED APPLICATIONS

The present application is a conversion of U.S. Provisional Application having U.S. Serial No. 63/670,465, filed July 12, 2024, which claims the benefit under 35 U.S.C. 119(e), the disclosures of which are hereby expressly incorporated herein by reference.

### BACKGROUND OF THE DISCLOSURE

### 1. Field of the Invention

The present disclosure relates to a davit arm base and a method of installing and using the davit arm base.

### 2. Description of the Related Art

A davit arm is a crane-like fall protection suspension system used to safely lower and raise workers and/or equipment from heights or in confined spaces. Oil and gas operations use davit arms for various operations, but there is an issue getting them close to the well where they are often needed.

Accordingly, there is a need for davit arm base for use with the davit arm and a method of using and installing the davit arm base to permit use of the davit arm in a more advantageous location relative to an oil and gas well. More specifically, the davit arm base permits use of the davit arm in more advantageous locations relative to a drilling rig or workover rig.

### SUMMARY OF THE INVENTION

The present disclosure is directed to a davit arm base for supporting a davit arm. The davit arm base includes a base plate for securing a davit base mount thereto and a sleeve extending from the base plate for extending down into a mouse hole for an oil and gas well. The present disclosure is also directed to a method. The method includes the step of sliding a sleeve of a davit arm base into a mouse hole and supporting a davit arm with via a base plate of the davit arm base.

### BRIEF DESCRIPTION OF THE DRAWINGS

FIG. 1 is a side elevation view of a davit arm connected to a davit arm base constructed in accordance with the present disclosure.

FIG. 2 is a perspective view of the davit arm base constructed in accordance with the present disclosure.

FIG. 3 is a perspective view of a well head and a mouse hole used with the davit arm base constructed in accordance with the present disclosure.

FIG. 4 is a perspective view of a davit base mount attached to the davit arm base constructed in accordance with the present disclosure.

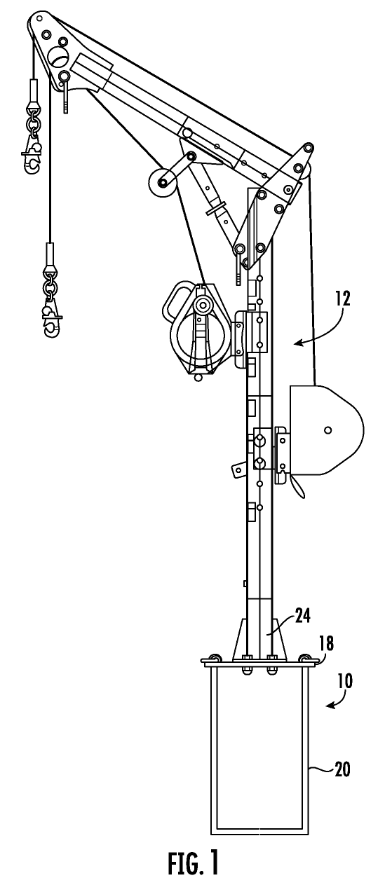

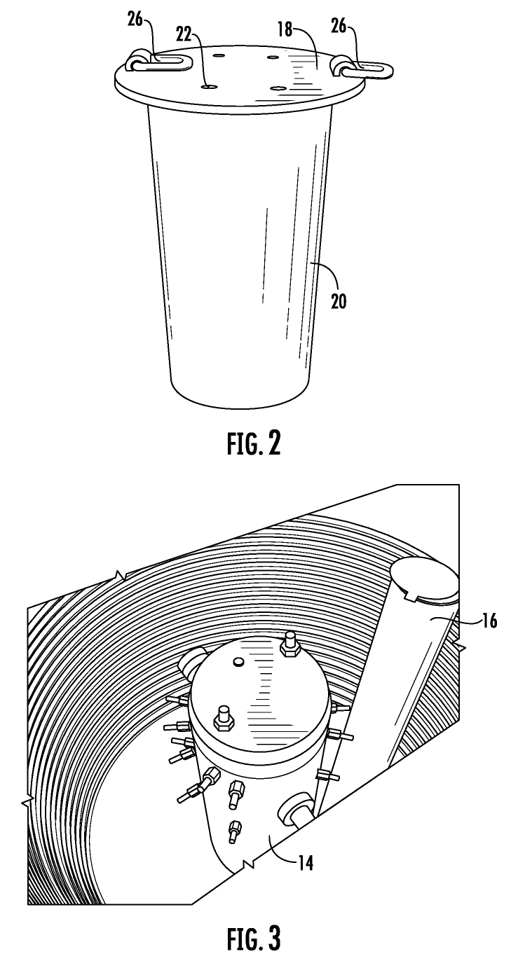

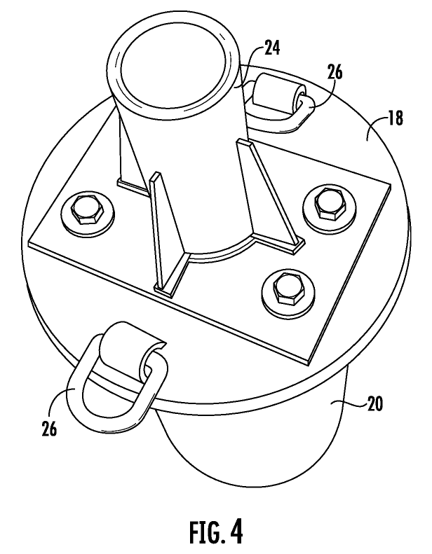

### DETAILED DESCRIPTION OF THE DISCLOSURE

The present disclosure relates to a davit arm base 10 for use with a davit arm 12 and a method of using and installing the davit arm base 10 so that the davit arm 12 can be used in a more advantageous position relative to an oil and gas well. An oil and gas well includes a well head 14 where primary oil and gas operations are conducted and a mouse hole 16 that is positioned a relatively short distance from the well head 14. The davit arm base 10 can be installed in the mouse hole 16 to provide a more advantageous location of the davit arm 12 relative to the well head 14. The davit arm 12 positioned above the mouse hole 16 and that close to the well head 14 provides the operators of the oil and gas well a way to get people closer to the well head 14 in a much safer manner.

The davit arm base 10 includes a base plate 18 and a sleeve 20 extending therefrom. The sleeve 20 is sized and shaped such that it can be slid down into the mouse hole 16 and securely support the davit arm 12. The base plate 18 of the davit arm base 10 can include mounting holes 22 disposed therein to provide a place where a davit base mount 24 can be secured to the davit arm base 10. The davit base mount 24 can be a standard device that supports davit arms 12 and can be mounted to various pieces of equipment used to support davit arms 12.

The sleeve 20 can have a length that is sufficient to securely support the davit arm 12 when the sleeve 20 is inserted into the mouse hole 16. The sleeve 20 can have a sidewall thickness that is sufficient to securely support the davit arm 12. In one embodiment, the length of the sleeve 20 can depend on the thickness of the sidewall. For example, a davit arm base 10 with a longer sleeve 20 could potentially have a smaller sidewall thickness. Conversely, a davit arm base 10 with a shorter sleeve 20 could have a larger sidewall thickness. In one embodiment, the sleeve 20 can have a length greater than about 10 inches. In another embodiment, the sleeve 20 can have a length greater than about 12 inches. In a further embodiment, the sleeve 20 can have a length greater than about 15 inches. In yet another embodiment, the sleeve 20 can have a length greater than about 18 inches. In an even further embodiment, the sleeve 20 can have a length greater than or equal to about 24 inches. In one embodiment, the thickness of the sidewall of the sleeve 20 can be greater than about 1/8^{th} of an inch. In another embodiment, the thickness of the sidewall of the sleeve 20 can be greater than about 1/4^{th} of an inch. In a further embodiment, the thickness of the sidewall of the sleeve 20 can be greater than about 3/8^{th} of an inch. In yet another embodiment, the thickness of the sidewall of the sleeve 20 can be greater than or equal to about 1/2 of an inch.

The sleeve 20 of the davit arm base 10 can have a certain diameter that is responsive to the inner diameter of the mouse hole 16. In one embodiment, the diameter of the sleeve 20 is 1/8^{th} of an inch less than the inner diameter of the mouse hole 16. In another embodiment, the diameter of the sleeve 20 is 1/4^{th} of an inch less than the inner diameter of the mouse hole 16. In a further embodiment, the diameter of the sleeve 20 is 3/8^{th} of an inch less than the inner diameter of the mouse hole 16. In yet another embodiment, the diameter of the sleeve 20 is 1/2 of an inch less than the inner diameter of the mouse hole 16.

The base plate 18 of the davit arm base 10 can have a certain size diameter and thickness such that the davit arm 12 could be safely and securely supported by the davit arm base 10. The diameter of the base plate 18 can be sized such that it is at least as wide as the outer diameter of the mouse hole 16. In one embodiment, the diameter of the base plate 18 is at least 1/8^{th} of an inch wider than the outer diameter of the mouse hole 16. In another embodiment, the diameter of the base plate 18 is at least 1/4^{th} of an inch wider than the outer diameter of the mouse hole 16. In yet another embodiment, the diameter of the base plate 18 is at least 3/8^{th} of an inch wider than the outer diameter of the mouse hole 16. In an even further embodiment, the diameter of the base plate 18 is greater than at least 1/2 of an inch wider than the outer diameter of the mouse hole 16. In one embodiment, the thickness of the base plate 18 can be greater than about 1/8^{th} of an inch. In another embodiment, the thickness of the base plate 18 can be greater than about 1/4^{th} of an inch. In a further embodiment, the thickness of the base plate 18 can be greater than about 3/8^{th} of an inch. In yet another embodiment, the thickness of the base plate 18 can be greater than or equal to about 1/2 of an inch.

The davit arm base 10 can also include ring members 26 attached to the base plate 18 so that certain parts of the davit arm 12 can be attached thereto. The ring members 26 could be D-rings that are hingedly attached to the base plate 18. The ring members 26 can be positioned on any part of the base plate 18 and provided in any number such that the structural integrity of the davit arm base 10 is not compromised.

The present disclosure is also directed to a method of installing the davit arm base 10 in the mouse hole 16. The installation method includes the step of sliding the sleeve 20 of the davit arm base 10 down into a mouse hole 16, or some other hole positioned adjacent to the well head. The davit base mount 24 can be secured to the base plate 18 of the davit arm base 10 and the davit arm 12 can be engaged with the davit base mount 24. The davit base mount 24 could be secured to the base plate 18 of the davit arm base 10 prior to installing the davit arm base 10 into the mouse hole 16.

The davit arm base 10 can be designed and constructed based off the specific size of the mouse hole 16. The inner diameter and the outer diameter of the mouse hole 16 can be determined. The size of the sleeve 20 and the base plate 18 can then be determined based on the size of the mouse hole 16. Once the desired size of the sleeve 20 and the base plate 18 of the davit arm base 10 is determined, the davit arm base 10 is constructed to have a certain size to properly fit the mouse hole 16 and create a secure support for the davit arm 12.

From the above description, it is clear that the present disclosure is well adapted to carry out the objectives and to attain the advantages mentioned herein as well as those inherent in the disclosure. While presently preferred embodiments have been described herein, it will be understood that numerous changes may be made which will readily suggest themselves to those skilled in the art and which are accomplished within the spirit of the disclosure and claims.

What is claimed is:

1. A davit arm base for supporting a davit arm, the davit arm base comprising:
a base plate for securing a davit base mount thereto; and
a sleeve extending from the base plate for extending down into a mouse hole for an oil and gas well.

2. The davit arm base of claim 1, wherein an outer diameter of the sleeve is within a certain length of an inner diameter of the mouse hole.

3. The davit arm base of claim 2, wherein the outer diameter of the sleeve is 1/8^{th} of an inch less than the inner diameter of the mouse hole.

4. The davit arm base of claim 2, wherein the outer diameter of the sleeve is 3/8 of an inch less than the inner diameter of the mouse hole.

5. The davit arm base of claim 1, wherein a sidewall thickness of the sleeve is greater than about 1/8^{th} of an inch.

6. The davit arm base of claim 1, wherein a sidewall thickness of the sleeve is greater than about 3/8^{th} of an inch.

7. The davit arm base of claim 1, wherein the sleeve has a length great than about 12 inches.

8. The davit arm base of claim 1, wherein the sleeve has a length great than about 18 inches.

9. The davit arm base of claim 1, wherein the base plate has a thickness greater than about 1/4^{th} of an inch.

10. The davit arm base of claim 1, wherein the base plate has ring members secured thereto.

11. A method, the method comprising:
sliding a sleeve of a davit arm base into a mouse hole; and
supporting a davit arm with via a base plate of the davit arm base.

12. The method of claim 11, further comprising the steps of:
determining an inner diameter of the mouse hole;
constructing the davit arm base responsive to the inner diameter of the mouse hole.

13. The method of claim 12, wherein an outer diameter of the sleeve is 1/8^{th} of an inch less than the inner diameter of the mouse hole.

14. The method of claim 12, wherein an outer diameter of the sleeve is 3/8 of an inch less than the inner diameter of the mouse hole.

15. The method of claim 12, wherein a sidewall thickness of the sleeve is greater than about 1/8^{th} of an inch.

16. The method of claim 12, wherein a sidewall thickness of the sleeve is greater than about 3/8^{th} of an inch.

17. The method of claim 12, wherein the sleeve has a length great than about 12 inches.

18. The method of claim 12, wherein the sleeve has a length great than about 18 inches.

19. The method of claim 12, wherein the base plate has a thickness greater than about 1/4^{th} of an inch.

20. The method of claim 12, wherein the base plate has ring members secured thereto.
